(19) United States
(12) Patent Application Publication
(10) Pub. No.: US 2015/0111544 A1
(43) Pub. Date: Apr. 23, 2015

(54) ELECTRONICE DEVICE FOR INDICATING MISSED CALLS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: WU ZHOU, Shenzhen (CN)

(73) Assignees: HON HAI PREICISION INDUSTRY CO., LTD., New Taipei (TW); HONG FU JIN PRECISION INDUSTRY (ShenZhen) CO., LTD, Shenzhen (CN)

(21) Appl. No.: 14/141,483

(22) Filed: Dec. 27, 2013

(30) Foreign Application Priority Data
Oct. 21, 2013 (CN) 2013104932782

(51) Int. Cl. H04M 3/42; H04M 1/02

(52) U.S. Cl. CPC H04M 3/42195; H04M 1/0202
USPC 455/414.1

(57) ABSTRACT

An electronic device with a missed-call management includes a signal triggering module, a driving circuit, and an indicating circuit connected in that order. When there is a missed call, an incoming call signal of the electronic device is received by the signal triggering module. According to the received incoming call signal, the signal triggering module controls the indicating circuit to work. Once the missed call is known, the signal triggering module controls the indicating circuit to stop working

### BACKGROUND

1. Technical Field

The disclosure generally relates to electronic devices, and particularly to an electronic device having an indicating function for missed calls.

2. Description of the Related Art

Most electronic devices can communicate with others, such as mobile phones, and are in widespread use. When there is an incoming call and the call is not answered timely (i.e., a missed call), information of the missed call will be displayed on a display screen of the electronic device. For a user to know that there is a missed call or not, he or she must check the display screen. However, for many reasons, for example, the user forgetting to bring along the electronic device, or due to being busy, many important incoming calls may be missed, which is usually inconvenient and possibly disadvantageous for the user.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

FIG. 1 is a block diagram of an electronic device, according to an exemplary embodiment.

FIG. 2 is a circuit diagram of the electronic device shown in FIG. 1.

### DETAILED DESCRIPTION

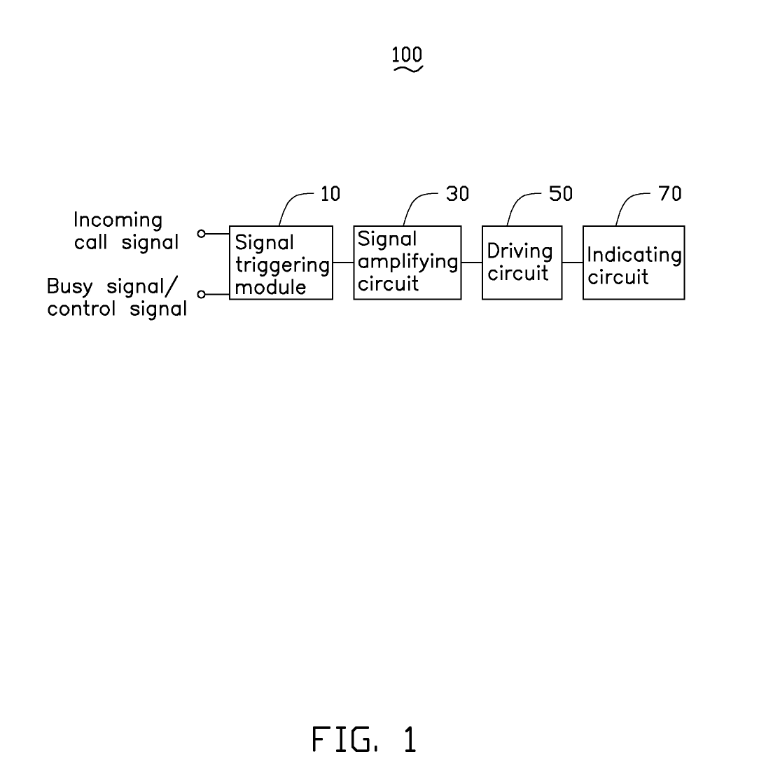

FIG. 1 is a block diagram of an electronic device 100, according to an exemplary embodiment. The electronic device 100 has a function of indicating missed calls. The electronic device 100 may be a mobile phone or other device having a communication function.

The electronic device 100 includes a signal triggering module 10, a signal amplifying circuit 30, a driving circuit 50, and an indicating circuit 70, electronically connected in that order. When there is an incoming call and is not answered, the electronic device 100 generates an incoming call signal. When the missed call is Known (e.g., a new incoming call is being answered), the electronic device 100 generates a busy signal. When a button (e.g., a hang up button) of the electronic device 100 is operated, which indicates a missed call, as the electronic device 100 generates a control signal. The signal triggering module 10 receives the incoming call signal, the busy signal, and the control signal, generate a triggering signal according to these signals, and sends the triggering signal to the signal amplifying circuit 30.

In detail, when the incoming call signal is received, the signal triggering module 10 processes the incoming call signal, generates a first triggering signal (e.g., a high level signal, logic 1) according to the incoming call signal, and sends the first triggering signal to the signal amplifying circuit 30. The signal amplifying circuit 30 amplifies current of the first triggering signal from the signal triggering module 10, and transmits the amplified first triggering signal to the driving circuit 50. Under the control of the amplified first triggering signal, the driving circuit 50 starts to work and generates a driving signal. The driving signal is sent to the indicating circuit 70 to control the indicating circuit 70 to work, such as blink or flash, which indicates a missed call.

Once the busy signal or the control signal is received, these indicate a missed call. In this way, the signal triggering module 10 processes the busy signal or the control signal, generates a second triggering signal opposite to the first triggering signal (e.g., a low level signal, logic 0) according to the busy signal or the control signal, and sends the second triggering signal to the signal amplifying circuit 30. The signal amplifying circuit 30 amplifies current of the second triggering signal, and sends the amplified second triggering signal to the driving circuit 50. Under the control of the amplified second triggering signal, the driving circuit 50 stops working and does not generate any signal to the indicating circuit 70, which causes the indicating circuit 70 to stop working

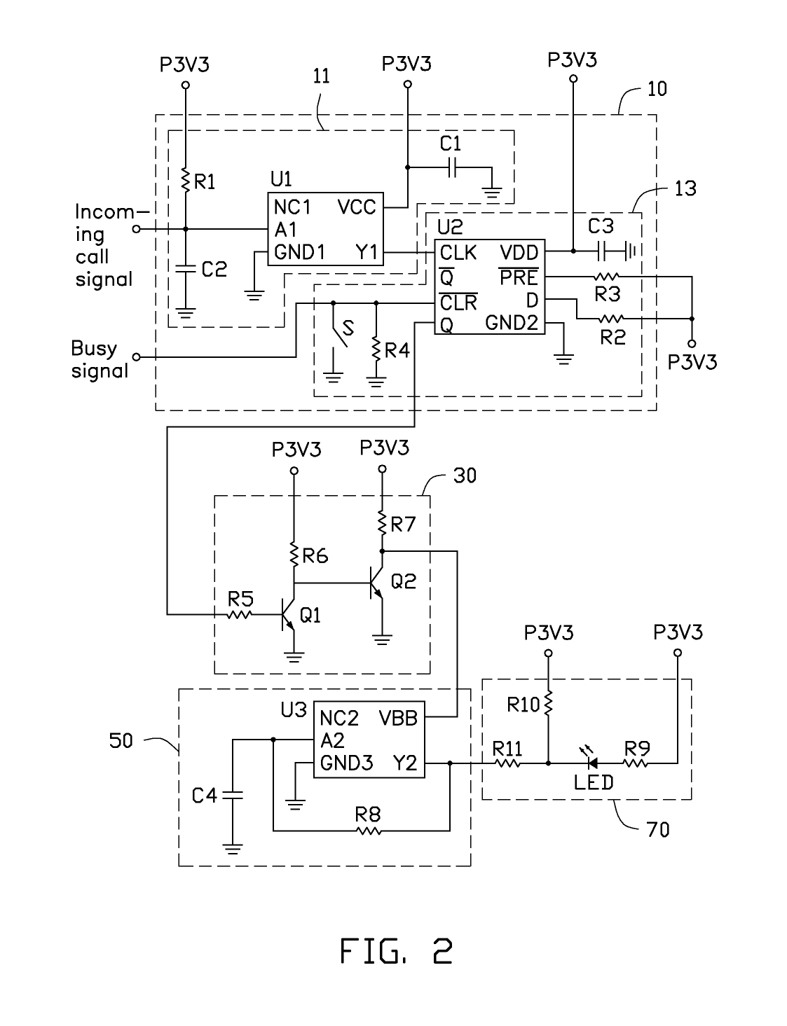

FIG. 2 shows that the signal triggering module 10 includes a signal processing circuit 11 and a signal triggering circuit 13. The signal processing circuit 11 includes a signal processing chip U1, a resistor R1, and capacitors C1-C2. In this exemplary embodiment, the signal processing chip U1 is a SN74LVC1G14DCKR inverter. The signal processing chip U1 includes a power pin VCC, a signal input pin A1, a signal output pin Y1, a grounding pin GND1, and an idle pin NC1. The power pin VCC is electronically connected to a power supply P3V3 and is grounded through the capacitor C1. The grounding pin GND1 is grounded. The idle pin NC1 is idle. The signal input pin A1 is electronically connected to the power supply P3V3 through the resistor R1 and is grounded through the capacitor C2. The signal input pin A1 receives the incoming call signal. The incoming call signal is inverted by the signal processing chip U1 and the inverted incoming call signal is output through the signal output pin Y1. In general, the incoming call signal is a low level signal (e.g., logic 0). Thus, when the signal input pin A1 receives the low level signal, the signal processing chip U1 inverts the low level signal, and outputs a high level signal through the signal output pin Y1.

The signal triggering circuit 13 includes a signal triggering chip U2, resistors R3-R4, a capacitor C3, and a control switch S. A type of the signal triggering chip U2 may be SN74LVC2G74DCUR. The signal triggering chip U2 includes a power pin VDD, a grounding pin GND2, a clock pin CLK, a data pin D, a preset pin P̅R̅E̅, a clearing pin C̅L̅R̅, a first output pin Q, and a second output pin Q̅. The power pin VDD is electronically connected to the power supply P3V3 and is grounded through the capacitor C3. The grounding pin GND2 is grounded. The data pin D is electronically connected to the power supply P3V3 through the resistor R2. The clock pin CLK is electronically connected to the signal output pin Y1 of the signal processing chip U1 and is configured to receive the processed incoming call signal. The preset pin P̅R̅E̅ is electronically connected to the power supply P3V3 through the resistor R3. The clearing pin CLR is electronically connected to the power supply P3V3 through the resistor R4 and receives the busy signal. The control switch S may be integrated with a commonly-used button (e.g., a hang up button) of the electronic device 100. An end of the control switch S is electronically connected to the clearing pin C̅L̅R̅, another end of the control switch S is grounded. When the missed call is known before any new call is received, the control switch S can be operated. Then, the clearing pin C̅L̅R̅ is grounded through the conducted control switch S to obtain the control signal. The first output pin Q is electronically connected to the signal amplifying circuit 30. The second output pin Q̅ is i idle. The first output pin Q outputs a triggering signal according to the incoming call signal, the busy signal, or the control signal.

In detail, when the signal triggering circuit 10 receives the incoming call signal through the clock pin CLK. Under a control of the clock pin CLK, the first output pin Q outputs the first triggering signal which is the same as the signal from the date pin D. In this exemplary embodiment, because the data pin D is connected to the power supply P3V3 through the resistor R2, the first triggering signal is a high level signal (e.g., logic 1). When a missed call is known, the signal triggering module 10 receives the busy signal or the control signal through the clearing pin CLR . In general, the clearing pin C̅L̅R̅ is enabled by a high level signal. Because the busy signal and the control signal are both low level signals, once the signal triggering module 10 receives the busy signal or the control signal through the clearing pin C̅L̅R̅, no matter what type of signal the clock pin CLK inputs, the first output pin Q outputs a second triggering signal opposite to the signal of the data pin D. In this exemplary embodiment, the second triggering signal is a low level signal (e.g., logic 0).

The signal amplifying circuit 30 is electronically connected between the signal triggering module 10 and the driving circuit 50. The signal amplifying circuit 30 amplifies a current of the triggering signal when the current of the triggering signal output by the signal triggering module 10 is not enough to drive the driving circuit 50 to work.

In detail, the signal amplifying circuit 30 includes a first transistor Q1, a second transistor Q2, and resistors R5-R7. The first transistor Q1 and the second transistor Q2 are both npn transistors. A base of the first transistor Q1 is regarded as an input end of the signal amplifying circuit 30 and is electronically connected to the first output pin Q through the resistor R5. An emitter of the first transistor Q1 is grounded. A collector of the first transistor Q1 is connected to the power supply P3V3 through the resistor R6. A base of the second transistor Q2 is connected to the collector of the first transistor Q1. An emitter of the second transistor Q2 is grounded. A collector of the second transistor Q2 is regarded as an output end of the signal amplifying circuit 30. The collector of the second transistor Q2 is electronically connected to the power supply P3V3 through the resistor R7 and is also electronically connected to the driving circuit 50.

When the input end of the signal amplifying circuit 30 (i.e., the base of the first transistor Q1) receives a high level signal the first transistor Q1 is turned on and the second transistor Q2 is turned off. In this way, the output of the signal amplifying circuit 30 (i.e., the collector of the second transistor Q2) is electronically connected to the power supply P3V3 and outputs a high level signal. An output current of the signal amplifying circuit 30 is amplified to β times an input current of the signal amplifying circuit 30 (parameter β is a common emitter current gain of the first transistor Q1 or of the second transistor Q2).

When the input end of the signal amplifying circuit 30 receives a low level signal, the first transistor Q1 is turned off and the second transistor Q2 is turned on. In this way, the output end of the signal amplifying circuit 30 is grounded by the conducting second transistor Q2 and outputs a low level signal. The signal amplifying circuit 30 only amplifies a current of the triggering signal and does not alter logical value of the triggering signal. That is, when the input of the signal amplifying circuit 30 is logic 1, the output of the signal amplifying circuit 30 is still logic 1. When the input of the signal amplifying circuit 30 is logic 0, the output of the signal amplifying circuit 30 is still logic 0.

The driving circuit 50 includes a drive chip U3, a resistor R8, and a capacitor C4. A type of the driving chip U3 may be SN74LVC1G14DCUKR. The driving chip U3 includes a power pin VBB, a signal input pin A2, a signal output pin Y2, a ground pin GND3, and an idle pin NC2. The power pin VBB is electronically connected to the output of the signal amplifying circuit 30, that is, the power pin VBB is electronically connected to the output of the signal triggering circuit 11 (i.e., the first output pin Q) through the signal amplifying circuit 30. The ground pin GND3 is grounded. The signal input pin A2 is connected to the signal output pin Y2 through the resistor R8, and is grounded through the capacitor C4. The signal output pin Y2 is further electronically connected to the indicating circuit 70.

When the driving circuit 50 receives the amplified first triggering signal, the driving circuit 50 is powered on and starts to work. In this way, the signal input pin A2, the resistor R8, and the capacitor C4 form a pulse generator to output a pulse signal having a frequency of about 1 Hertz to the indicating circuit 70. When the driving circuit 50 receives the second triggering signal, the driving circuit 50 stops working and does not output any signal.

The indicating circuit 70 includes a light emitting diode LED and resistors R9-R11. An anode of the light emitting diode LED is electronically connected to the power supply P3V3 through the resistor R9. A cathode of the light emitting diode LED is electronically connected to power supply P3V3 through the resistor R10, and is electronically connected to the output of the driving circuit 50 (i.e., the signal output pin Y2) by the resistor R11.

When the driving circuit 50 outputs the pulse signal through the signal output pin Y2, the light emitting diode LED flashes to indicate that there is a missed call. When the driving circuit 50 does not output any signal, the cathode of the light emitting diode LED is electronically connected to the power supply P3V3 through the resistor R10. The light emitting diode LED is turned off and does not emit any light.

In use of the electronic device 100, when there is an incoming call and which is missed, the electronic device 100 generates an incoming call signal. The signal processing circuit 11 receives the incoming call signal. The signal processing chip U1 processes the incoming call signal and outputs a inverted incoming call signal to the signal triggering circuit 13 through the signal output pin Y1. The signal triggering circuit 13 receives the inverted incoming call signal through the clock pin CLK and outputs a first triggering signal. The signal amplifying circuit 30 amplifies the current of first triggering signal to drive the driving circuit 50 to work. In this way, the signal input pin A2, the resistor R8, and the capacitor C4 of the driving circuit 50 form a pulse generator to output a pulse signal to the indicating circuit 70. Under the control of the pulse signal from the driving circuit 50, the light emitting diode LED flashes to indicate that there is a missed call.

Once the missed call is known (e.g., a new incoming call is answered or the control switch S is operated), the electronic device 100 generates a busy signal or a control signal. The signal triggering circuit 13 receives the busy signal or the control signal and outputs a second triggering signal opposite to the first triggering signal through the first output pin Q. The second triggering signal is transmitted to the driving circuit 50 through the signal amplifying circuit 30 so as to control the driving circuit 50 to stop working. In this way, the driving circuit 50 does not output any signal. The cathode of the light emitting diode LED is connected to the power supply P3V3 through the resistor R10. The light emitting diode LED is turned off and does not emit any light.

When the clock pin CLK is enabled by a low level signal, the signal processing circuit 11 can be omitted and the clock pin CLK can receive the incoming call signal directly.

When a current of the triggering signal of the signal triggering module 10 is always enough to drive the driving circuit 50 to work, the signal amplifying circuit 30 can be omitted, and the signal triggering module 10 is electronically connected to the driving circuit 50 directly.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. An electronic device, comprising:
a signal triggering module;
a driving circuit electronically connected to the signal triggering module; and
an indicating circuit electronically connected to the driving circuit;
wherein in response to a missed call, an incoming call signal of the electronic device is received by the signal triggering module, the signal triggering module controls the driving circuit to start to work, and the driving circuit controls the indicating circuit to work; when the missed call is known, a busy signal or a control signal is received by the signal triggering module, the signal triggering module controls the driving circuit to stop to work, and the indicating circuit stops to work.

2. The electronic device of claim 1, wherein the signal triggering module comprises a signal triggering circuit, the signal triggering circuit comprises a signal triggering chip, the signal triggering chip comprises a power pin, a clock pin, a data pin, a preset pin and a first output pin, the power pin is connected to a power supply, the clock pin receives the incoming call signal, the preset pin is connected to the power supply, the first output pin is connected to the driving circuit.

3. The electronic device of claim 2, wherein the signal triggering chip further comprises a clearing pin, the clearing pin is connected to the power supply and receives the busy signal.

4. The electronic device of claim 3, wherein the signal triggering circuit further comprises a control switch, an end of the control switch is grounded; another end of the control switch is connected to the clearing pin and generates the control signal.

5. The electronic device of claim 2, wherein when the clock pin is enabled by a high level signal, the signal triggering module further comprises a signal processing circuit connected to the clock pin, the signal processing circuit receives the incoming call signal, inverts the incoming call signal, and sends the inverted incoming call signal to the clock pin.

6. The electronic device of claim 5, wherein the signal processing circuit comprises a signal processing chip, the signal processing chip comprises a power supply, a signal input pin, a signal output pin, the power pin of the signal processing chip is connected to the power supply and is grounded through a capacitor, the signal input pin of the signal processing chip is connected to the power supply through a resistor and is grounded through a capacitor, the signal output pin of the signal processing chip is connected to the clock pin, the signal input pin of the signal processing chip inverts the incoming call signal through the signal processing chip, and outputs the inverted incoming call signal through the signal output pin of the signal processing chip to the clock pin.

7. The electronic device of claim 2, wherein the driving circuit comprises a driving chip, the driving chip comprises a power pin, a signal input pin, and a signal output pin, the power pin of the driving chip is connected to the first output pin, the signal input pin of the driving chip is connected to the signal output pin of the driving chip through a resistor and is grounded through a capacitor, the signal output pin of the driving chip is connected to the indicating circuit.

8. The electronic device of claim 7, wherein when the signal triggering circuit receives the incoming call signal, the driving circuit is powered on and starts to work, the signal input pin of the driving chip, the resistor of the driving circuit, and the capacitor of the driving circuit form a pulse generator to output a pulse signal to the indicating circuit;
when the signal triggering circuit receives the busy signal or the control signal, the driving circuit stops to work and does not output any signal.

9. The electronic device of claim 8, wherein the indicating circuit comprises a light emitting diode, an anode of the light emitting diode is connected to the power supply through a resistor, a cathode of the light emitting diode is connected the power supply through a resistor and is connected to the signal output pin of the driving circuit, when the driving circuit outputs the pulse signal, the light emitting diode flashes, when the driving circuit does not output any signal, the light emitting diode is turned off

10. The power adjustment device of claim 7, further comprising a signal amplifying circuit, wherein the signal amplifying circuit is connected between the signal triggering module and the driving circuit.

11. The power adjustment device of claim 10, wherein the signal amplifying circuit comprises a first transistor and a second transistor, a base of the first transistor is electronically connected to the first output pin through a resistor, an emitter of the first transistor is grounded, a collector of the first transistor is connected to the power supply through the resistor, a base of the second transistor is connected to the collector of the first transistor, an emitter of the second transistor is grounded, a collector of the second transistor is electronically connected to the power supply through the resistor, and also connected to the power pin of the driving circuit.
